(19) United States
(12) Patent Application Publication
(10) Pub. No.: US 2015/0213107 A1
(43) Pub. Date: Jul. 30, 2015

(54) APPARATUS OF MANAGING DATA AND METHOD FOR MANAGING DATA FOR SUPPORTING MIXED WORKLOAD

(71) Applicant: Electronics and Telecommunications Research Institute, Daejeon (KR)

(72) Inventors: Kyoung Hyun PARK, Daejeon (KR); Mai Hai THANH, Daejeon (KR); Hun Soon LEE, Daejeon (KR); Chang Soo KIM, Daejeon (KR); Mi Young LEE, Daejeon (KR)

(21) Appl. No.: 14/595,138

(22) Filed: Jan. 12, 2015

(30) Foreign Application Priority Data
Jan. 28, 2014 (KR) 10-2014-0010292

(51) Int. Cl. G06F 17/30

(52) U.S. Cl. CPC G06F 17/30592; G06F 17/30563; G06F 17/30598; G06F 17/30864

(57) ABSTRACT

An apparatus of managing data according to the present invention includes a query processor, a page monitor, a page layout manager and a data storage manager. The query processor processes a user query. At the time of processing the user query, the page monitor collects accessed column information and selectivity information of accessed columns from the query processor and collects access page information from a data storage manager to create page monitoring information. The page layout manager creates page column group information by grouping columns adjacent to each other for each page at a predetermined time interval based on the page monitoring information. The data storage manager stores data in a main memory by reconfiguring a page based on the page column group information for a candidate page of which an access frequency is greater than a predetermined access frequency based on the page monitoring information.

### CROSS-REFERENCE TO RELATED APPLICATIONS

This application claims priority to and the benefit of Korean Patent Application No. 10-2014-0010292 filed in the Korean Intellectual Property Office on Jan. 28, 2014, the entire contents of which are incorporated herein by reference.

### TECHNICAL FIELD

The present invention relates to an apparatus and a method for managing data, and more particularly, to an apparatus of managing data and a method of managing data that reconfigure a layout by the unit of a column included in a page in order to support a mixed workload.

### BACKGROUND ART

Database markets have been developed while being divided into an online transmission processing (OLTP) market and an online analytical processing (OLAP) market. OLTP performs a write/read operation on a small amount of data by focusing on transaction, while OLAP sequentially searches for and analyzes only a minority of columns of a large amount of data by focusing on data analysis.

However, as an enterprise computing market shifts to a real-time big data management and analysis market, discrimination of the OLTP and OLAP markets becomes gradually obscure. For example, an available-to-promise system processes an OLTP type query in order to determine whether to process an order, but should perform a statistical operation for determining the amount of inventory in real time by using an OLAP type query in order to process the order.

As such, a recent database market requires a function to process not a specific workload type but a mixed workload of the OLAP and the OLTP, but recent database systems cannot sufficiently satisfy such a requirement.

One of the most important causes therefor may be that a data storage structure of database is designed as a static storage structure. That is, since a structure of a record stored in a page is statically fixed, a workload which is not suitable for a page structure cannot be efficiently processed.

For example, the database system may be divided into a row store and a column store according to a data storage method, and since the row store representing a general relational database stores data in the page by the unit of the record, the row store is suitable for the OLTP workload that approaches a minority of records. On the contrary, the column store that stores data in the page by the unit of the column is more suitable for the OLAP workload that accesses a specific column for a large amount of data.

Since a page storage model is determined according to a characteristic of the workload, the existing static storage structure cannot efficiently process various types of workloads in which the OLTP and the OLAP are mixed each other that are gradually increased under a current enterprise environment.

In order to solve such a problem, a HANA database system which is an in-memory database system of an SAP includes both a row store engine and a column store engine. As a result, the workload is processed by using an engine suitable for a characteristic of a workload to be processed.

Another research (Hasso Plattner, “A common database approach for OLTP and OLAP using an in-memory column database”, 2009) asserts that an in-memory column store is suitable for processing the mixed workload of the OLAP and the OLTP. That is, the research asserts that the development of an in-memory computing environment and hardware allows the in-memory column store to process the mixed workload of the OLAP and the OLTP with low performance deterioration. However, this method also shows that the performance deterioration is not greater than that of the existing system but does not present a fundamental solution for efficiently processing the mixed workload.

Besides, numerous researches have been done and a system that periodically changes a data storage model to be suitable for the characteristic of the workload starts to be developed.

For example, a Hyrise system (five persons other than Martin Grund, “HYRISE—A Main Memory Hybrid Storage Engine”, 2010) is an in-memory based hybrid database storage system for processing the mixed workload. The Hyrise system efficiently processes the mixed workload by vertically segmenting and managing a table by the unit of a column group to be suitable for the characteristic of the workload.

However, since the Hyrise system reflects the page storage model reflecting the characteristic of the workload by the unit of the table, that is, since the Hyrise system has the page storage model reflecting the corresponding workload even though a certain page is not accessed by the workload, it is difficult to regard that the characteristic of the workload is accurately reflected.

Even in a page storage model technology field, researches for processing the mixed workload have been done. Among them, a representative page storage model is Data Morphing (Richard A. Hankins et al, “Data Morphing: An Adaptive, Cache-Conscious Storage Technique”, 2003). The data morphing is a technique that creates a column group which is low in cost by periodically analyzing the mixed workload, and dynamically creates and manages a page based on the column group so as to efficiently process the mixed workload. Since the data morphing scheme groups columns in the table as a column group and stores the columns in the page by the unit of the column group, cache misses scarcely occur in the data morphing comparing with the existing page storage model. However, since a cost model is defined based on full scan, it is difficult to calculate relatively accurate cost for query operations other than the full scan. Since the column group is reflected by the unit of the table, column group information is reflected to even all pages not influenced by the corresponding workload even when a specific workload accesses only specific pages, and as a result, a page is created, which does not reflect the characteristic of the workload relatively accurately.

### SUMMARY OF THE INVENTION

The present invention has been made in an effort to provide an apparatus of managing data and a method of managing data that can efficiently process a mixed workload by creating a column group reflecting a characteristic of a workload and periodically applying the created column group to a page layout.

The present invention has also been made in an effort to provide an apparatus of managing data and a method of managing data that can configure a suitable page layout for each query by reconfiguring a column group for each page in a table.

The technical objects of the present invention are not limited to the aforementioned technical objects, and other technical objects, which are not mentioned above, will be apparent to those skilled in the art from the following description.

An embodiment of the present invention provides an apparatus of managing data, including: a query processor suitable for processing a user query; a page monitor suitable for collecting accessed column information and selectivity information of accessed columns from the query processor and collecting access page information from a data storage manager to create page monitoring information; a page layout manager suitable for creating page column group information by grouping columns adjacent to each other for each page at a predetermined time interval based on the page monitoring information; and the data storage manager suitable for storing data in a main memory by reconfiguring a page based on the page column group information for a candidate page of which an access frequency is more than a predetermined access frequency based on the page monitoring information. The data storage manager may include: a candidate page filtering unit suitable for selecting the candidate page based on the page monitoring information; and a dynamic page layout reconfigurer including a candidate page reconfigurer suitable for reconfiguring the candidate page by comparing page column group information of the candidate page and a column group of the candidate page on the main memory.

For example, the candidate page reconfigurer may calculate the sizes of sub pages constituting the candidate page based on the page column group information to create each sub page in a newly allocated page on the main memory.

The candidate page reconfigurer may copy and store data written in the column of the candidate page into the newly allocated page on the main memory according to the page column group information and when the copying is completed, the candidate page reconfigurer may delete the data written in the column of the candidate page.

The page layout manager may cluster columns to one or more groups for each page, create a combinational column group for each group, and select a candidate column group by applying the cost model to the combinational column group to create the page column group information. For example, the page layout manager may create the page column group information so as to create the column group in a pattern of a single cluster for each page.

Another embodiment of the present invention provides a method of managing data, including: creating, at the time of processing a user query, page monitoring information by collecting accessed column information, selectivity of accessed columns, and access page information; creating page column group information at a predetermined time interval by grouping columns positioned adjacent to each other for each page based on the page monitoring information; reconfiguring a page based on the page column group information for a candidate page of which an access frequency is more than a predetermined access frequency based on the page monitoring information; and storing data in a main memory based on the reconfigured page column group information.

The creating of the page column group information may include selecting a combination of column groups having minimum cost by grouping a plurality of columns constituting the page based on a cost model for each page to create the selected combination as the page column group information.

The creating of the page column group information may include: clustering columns constituting the page to a group constituted by one or more columns; creating combinational column groups corresponding to combinations of columns available for each clustered group; selecting a candidate column group by applying the cost model to the combinational column groups; and selecting the combination of the candidate column group having minimum cost when the page is constituted to create the selected combination as the page column group information. For example, the creating of the page column group information may be repeatedly performed until the number of the clustered groups decreases to one.

The reconfiguring of the page may include: selecting the candidate page among pages constituting the main memory; comparing the page column group information of the candidate page and the column group of the candidate page on the main memory; and reconfiguring the candidate pages based on the comparison result.

The method may further include calculating the size of the sub page constituting the candidate page based on the page column group information.

The calculating of the size of the sub page may include calculating the size of the sub page by averaging the size of the candidate page of the main memory by the number of columns when the sizes of records stored in columns constituting the sub page are variable.

The storing of data in the main memory may include: allocating a new page on the main memory; and copying and storing data written in the candidate page on the main memory to and in the allocated page.

According to embodiments of the present invention, an apparatus of managing data and a method of managing data create a column group depending on a workload by periodically analyzing a characteristic of the workload and dynamically reflect the created column group to a page to efficiently process a mixed workload of OLAP and OLTP which the existing systems were difficult to process.

The apparatus and the method for managing data can apply different layouts to respective pages constituting a table to enable data processing suitable for a query.

The embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the embodiments of the present invention. It can be easily known that the objects and advantages of the present invention can be implemented by the means and a combination thereof described in the appended claims.

### BRIEF DESCRIPTION OF THE DRAWINGS

FIG. 1 is a block diagram illustrating an apparatus of managing data according to an embodiment of the present invention.

FIG. 2 is a diagram for describing creation of page monitoring information according to an embodiment of the present invention.

FIG. 3 is a diagram for describing a page layout manager according to an embodiment of the present invention.

FIGS. 4 to 7 are diagrams for describing a process of creating page column group information in a layout manager.

FIG. 8 is a diagram for describing a page layout reconfiguring method according to an embodiment of the present invention.

FIG. 9 is a flowchart for describing an operation of a candidate page reconfigurer according to an embodiment of the present invention.

FIG. 10 is a block diagram illustrating a computer system for performing the method of managing data according to an embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings. Like reference numerals refer to like elements in the drawings and a duplicated description of like elements will be skipped.

Specific structural or functional descriptions of embodiments of the present invention disclosed in the specification are made only for the purposes of describing the embodiments of the present invention, and the embodiments of the present invention may be carried out in various forms, and it should not be construed that the present invention is limited to the embodiments described in the specification.

Terms such as first, second, A, B, (a), (b), and the like may be used in describing the components of the embodiments according to the present invention. The terms are only used to distinguish a constituent element from another constituent element, but nature or an order of the constituent element is not limited by the terms.

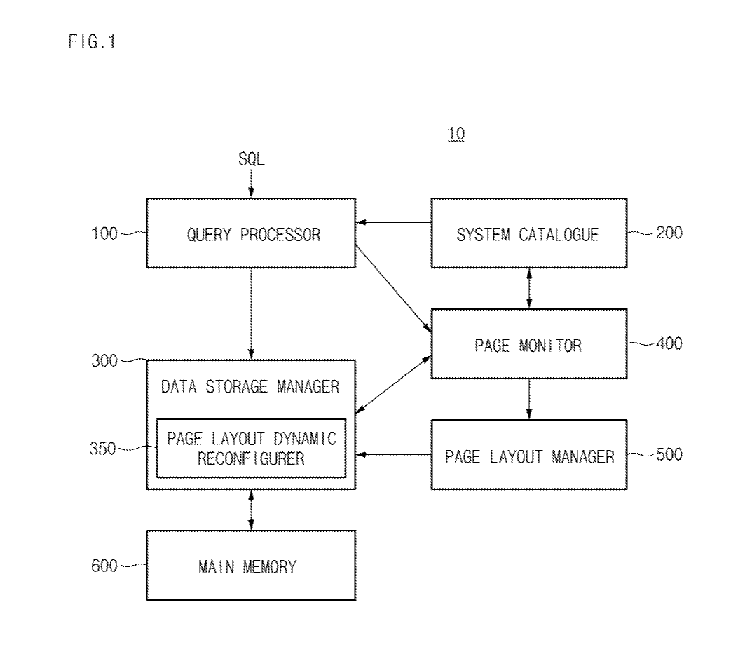

FIG. 1 is a block diagram illustrating an apparatus of managing data according to an embodiment of the present invention.

Referring to FIG. 1, the data managing apparatus 10 may include a query processor 100, a system catalogue 200, a data storage manager 300, a page monitor 400, and a page layout manager 500.

The query processor 100 parses a query by receiving a structured query language (SQL) and creates and optimizes a query plan, and thereafter, executes the query. The query processor 100 provides accessed column information to the page monitor 400. In detail, the query processor 100 provides to the page monitor 400 the accessed column information including columns accessed when the query is executed and selectivity of the respective columns. The selectivity represents a ratio of data in all columns to data to be accessed upon the query.

The system catalogue 200 is metadata storing schema information of a database, mapping information between schemas, and information required by components of the data managing apparatus 10. The system catalogue 200 may provide fundamental information on tables and columns to the page monitor 400.

The data storage manager 300 stores and manages data by the unit of a page in a main memory (not shown). The data storage manager 300 according to the embodiment of the present invention includes a dynamic page layout reconfigurer 350 to dynamically reconfigure and manage a specific page of the main memory based on column group information.

The page monitor 400 creates page monitoring information by monitoring accessed column information for each page constituting a table of the main memory to allow the page layout manager 500 to create the column information for respective page.

The page layout manager 500 periodically creates the page column group information suitable for the corresponding workload based on the page monitoring information received from the page monitor 400 and provides the created page column group information to the data storage manager 300.

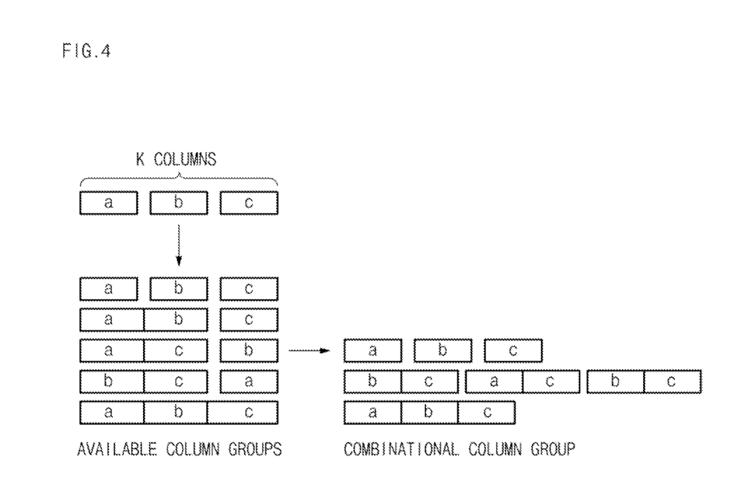

In the embodiment, the page layout manager 500 may create the page column group information based on a cost model and a column group selection algorithm. The creation of the column group information will be described in detail with reference to FIGS. 4 to 7.

The main memory may store data or transmit the stored data to the exterior according to the query in cooperation with the data storage manager 300. The main memory may be constituted by at least one volatile memory or non-volatile memory and in the present invention, the main memory may include a table in which each of the memories is constituted by a plurality of pages. Each page may include a plurality of columns.

For example, one page of the main memory may be accessed according to a query from a user. Since the data managing apparatus 10 according to the embodiment of the present invention may have a data configuration optimized for the query by reconfiguring the layout by the unit of the page, the data managing apparatus 10 may operate to be suitable for the mixed workload.

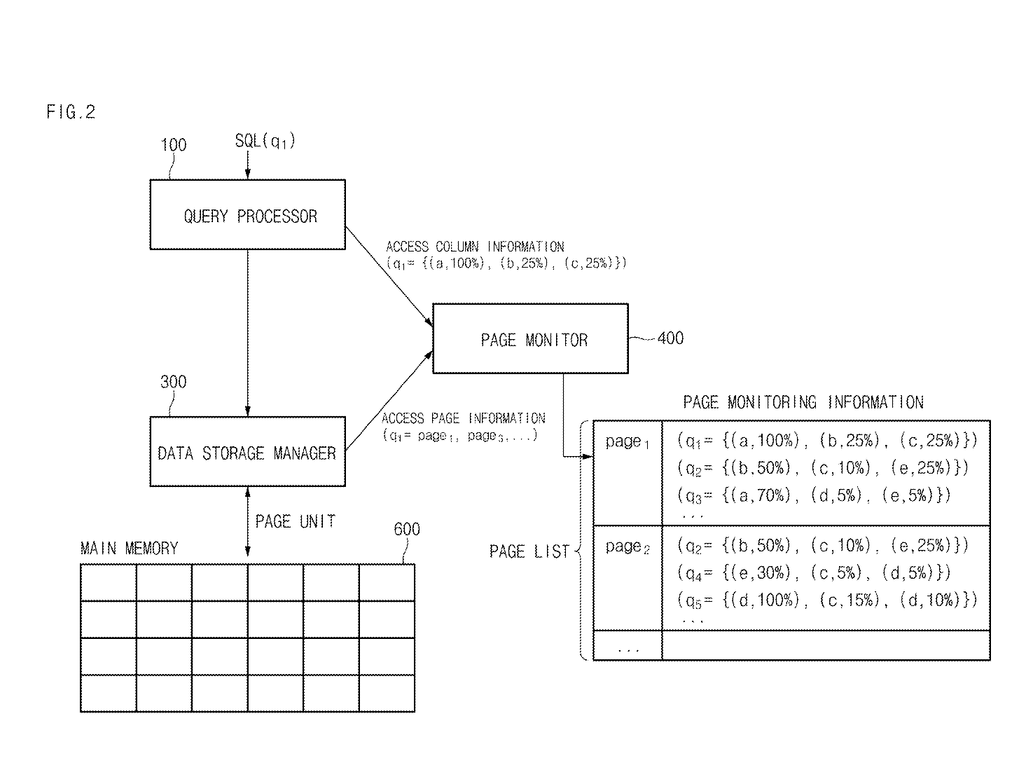

FIG. 2 is a diagram for describing creation of page monitoring information according to the embodiment of the present invention.

Referring to FIG. 2, when a first query q1 is provided, the page monitor 400 collects accessed column information including access information (a, b, and c) to be accessed in response to the first query q1 from the query processor 100 and selectivity information (100%, 25%, and 25%) of the accessed columns.

The page monitor 400 collects page information accessed when the first query q1 is executed from the data storage manager 300.

Information collected from the query processor 100 and the data storage manager 300 is integrated, and as a result, the page monitor 400 may monitor information of accessed pages at the time of performing a specific query, and accessed columns and access selectivity information.

As a result, the page monitoring information managed by the page monitor 400 is managed by a page list (page₁, page₂, and the like) and the respective pages on the list are managed by a list of query information. Each query information includes selectivity information and column information accessed when the query is received by the query processor 100.

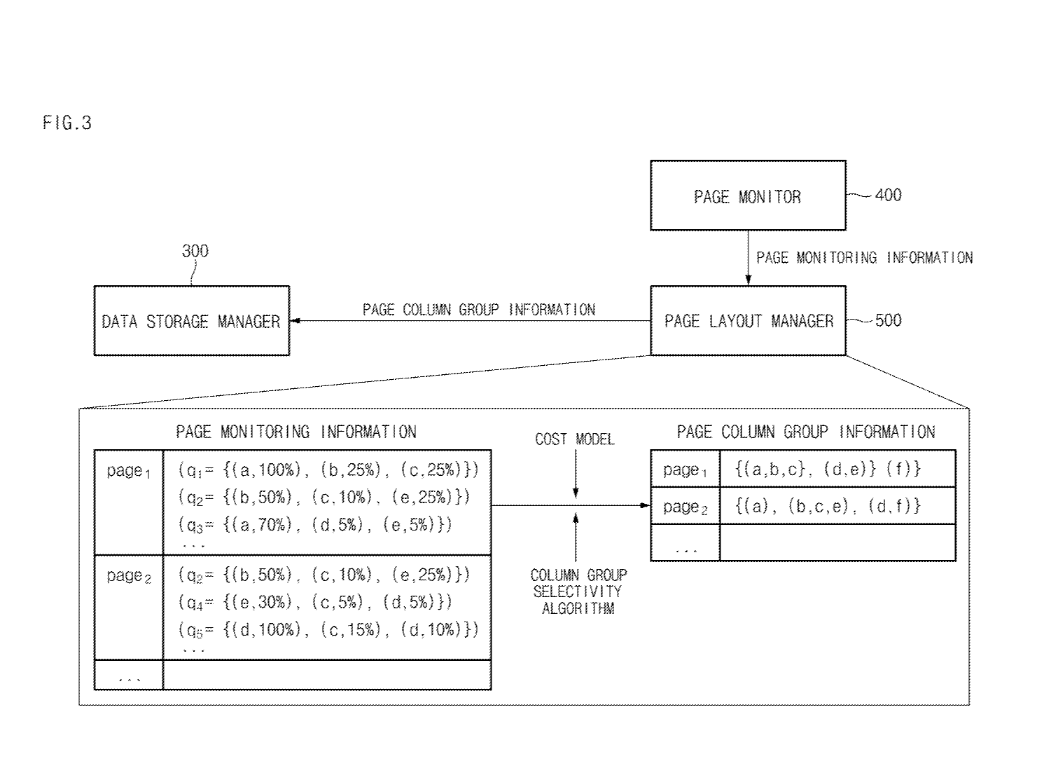

FIG. 3 is a diagram for describing a page layout manager according to an embodiment of the present invention.

Referring to FIG. 3, the page layout manager 500 periodically creates the page column group information based on the column information accessed at the time of performing the query for each page.

The layout manager 500 creates the page column group information by grouping columns adjacent to each other for the respective pages by using the cost model and the column group selectivity algorithm based on the page monitoring information received from the page monitor 400. Herein, the columns adjacent to each other may be columns that tend to be simultaneously accessed when the specific query is performed.

The cost model may be a cost model based on the cache miss. The cost model calculates the number of cache misses which occur at the time of processing each workload as cost. Accordingly, the page layout manager 500 creates the page column group information to minimize the number of cache misses which occur at the time of processing the workload by applying the cost model to each workload.

The cost model used in the present invention is a cost model based on the cache miss in the related art and will not be described in detail.

FIGS. 4 to 7 are diagrams for describing a process of creating page column group information in a layout manager. Hereinafter, the method in which the page layout manager 500 creates the column group information for each page will be described with reference to FIGS. 4 to 7.

For creating the page column group information grouping adjacent columns, cost for a combination of all available column groups is calculated and a combination of column groups which cause the least cost is selected.

However, since one table may include hundreds of columns under an enterprise environment, significant overhead occurs in calculating the combination of all of possible column groups, and as a result, actual application of the calculation is impossible. Accordingly, the column group selectivity algorithm used in the present invention is based on a method of selecting an optimal column group based on a clustering technique.

Hereinafter, the method of selecting the optimal combination of the column groups, which is suitable for the workload will be described. Steps of the method to be described below may be performed by the page layout manager 500 illustrated in FIG. 1.

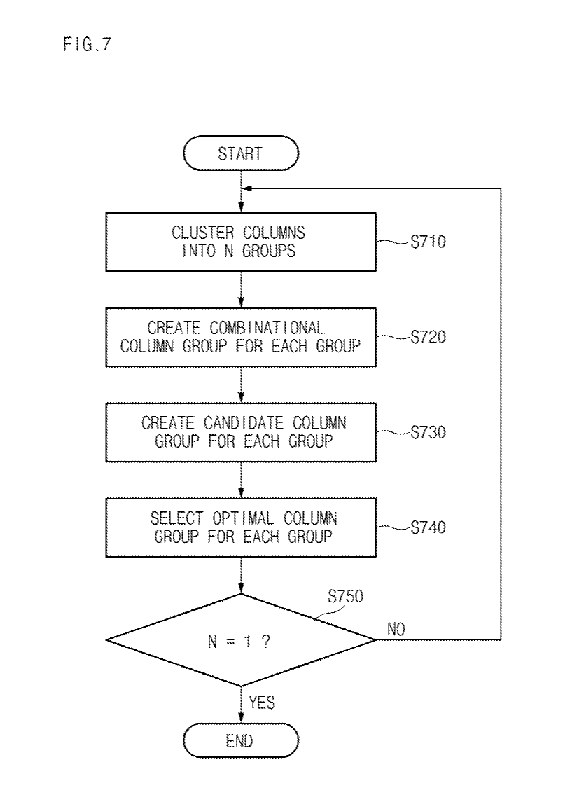

Referring to FIG. 7, columns constituting the page are clustered into N (N is a natural number) groups (step S710). N which is the number of the clustered groups is determined by K (K is a natural number) which is the number of columns included in each group. For example, in the case where the number of the columns constituting the page is 100 and the number of columns constituting one group is 5, the columns are clustered into 20 groups. A criterion of the clustering is to minimize cost by calculating a distance between the respective columns as cache miss cost.

After the clustering into N groups, all column group combinations which are available for each group are created. Hereinafter, selecting the optimal column group combination in one group will be described.

Referring to FIG. 4, K columns exist in the clustered group and it is described that column a, column b, and column c exist as an example in FIG. 4.

The page layout manager 500 determines available column group combinations of three columns and creates a combinational column group among them (step S710).

For example, consider that column a, column b, and column c exist. There may be a case where column a and column b constitute the column group and column c exists, a case where column a, column b, and column c respectively exist, and a case where column a, column b and column c constitute one column group. Like this, the available column group combinations may be determined such as the case where all of columns a to c constitute the column group. Among them, the combinational column group is acquired by deriving the cases where the columns may constitute the combination. In FIG. 4, three cases ({a}, {b}, {c}) in which one column constitutes the combinational column group may exist, three cases ({a, b}, {a, c}, {b, c}) in which two columns constitute the combinational column group may exist, and one case ({a, b, c}) in which three columns constitute the combinational column group may exist.

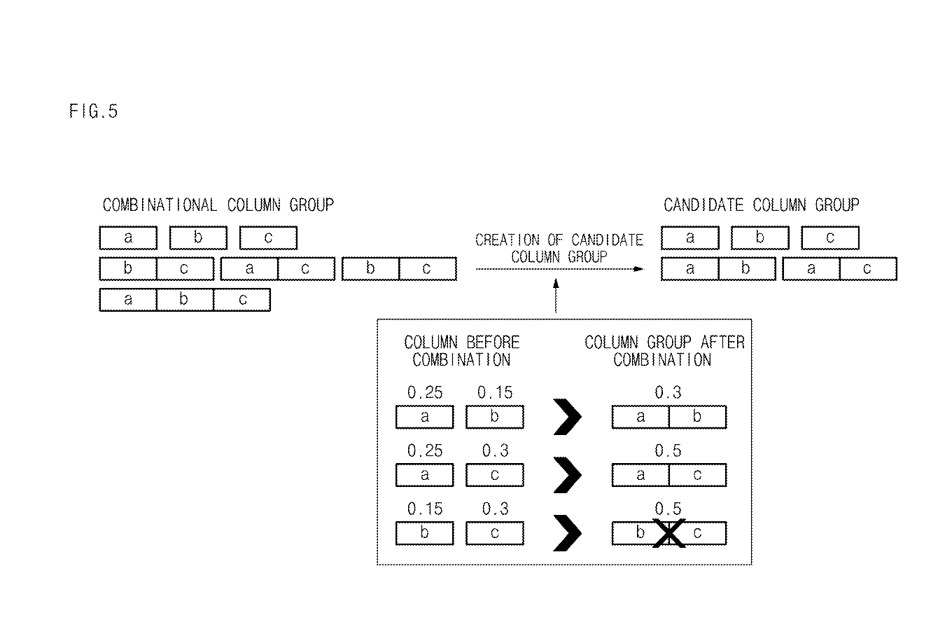

Referring to FIG. 5, a candidate column group is created by applying the cost model to the combinational column group (step S730). For example, since the sum of costs of column a and column b is 0.35 and cost of the combinational column group {a, b} is 0.3, the combinational column group {a, b} is selected as the candidate column group. Similarly, since the sum of costs of column a and column c is 0.55 and cost of the combinational column group {a, c} is 0.5, the combinational column group {a, c} is selected as the candidate column group.

However, in the case of column b and column c, since cost of the combinational column group {b, c} is 0.5 which is greater than 0.45 which is the sum of costs of column b and column c, the combinational column group {b, c} is excluded from the candidate column group. Although not illustrated in FIG. 5, since the cost of the combinational column group {a, b, c} is smaller than any one of the sum of costs of column a, column b, and column c, the sum of costs of the combinational column group {a, b} and column c, the sum of costs of the combinational column group {a, c} and column b, and the sum of costs of the combinational column group {b, c} and column a, the combinational column group {a, b, c} is excluded from the candidate column group.

Through such a process, column a, column b, column c, the column group {a, b}, and the column group {a, c} are selected as the candidate column group.

The page layout manager 500 selects a column group that causes minimum cost among all page constituent combinations constituted by the candidate column groups as the optimal column group (step S740).

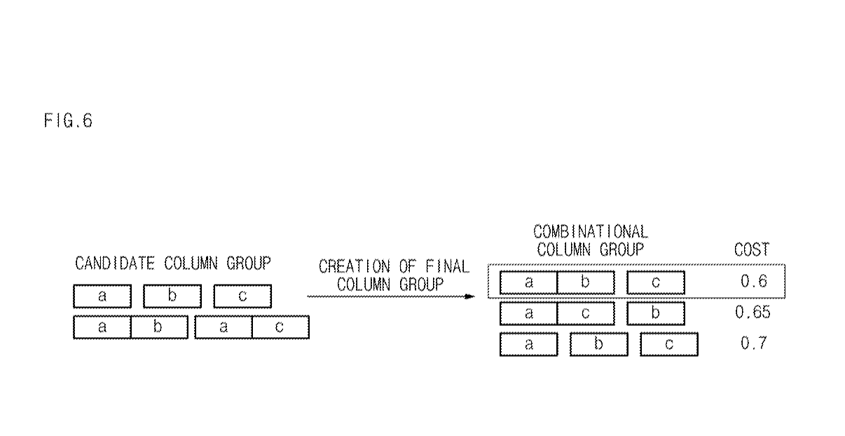

Referring to FIG. 6, in order to form an initial clustered group {a, b, c} by using a combination of the candidate column groups, three combinations of a combination of the column group {a, b} and column c, a combination of the column group {a, c} and column b, ad a combination of column a and column b, and column c may be assumed.

When the costs of the respective combinations are calculated, the combination of the column group {a, b} and column c may be selected as the optimal column group which causes minimum cost of 0.6.

The optimal column group may be selected in one clustered group as described above and the page layout manager 500 repeats the aforementioned process for N clustered groups for respective page. When such a process is repeated until the number of the clustered groups becomes 1, and thus, the corresponding column group is a final column group and is created as page column group information (step S750).

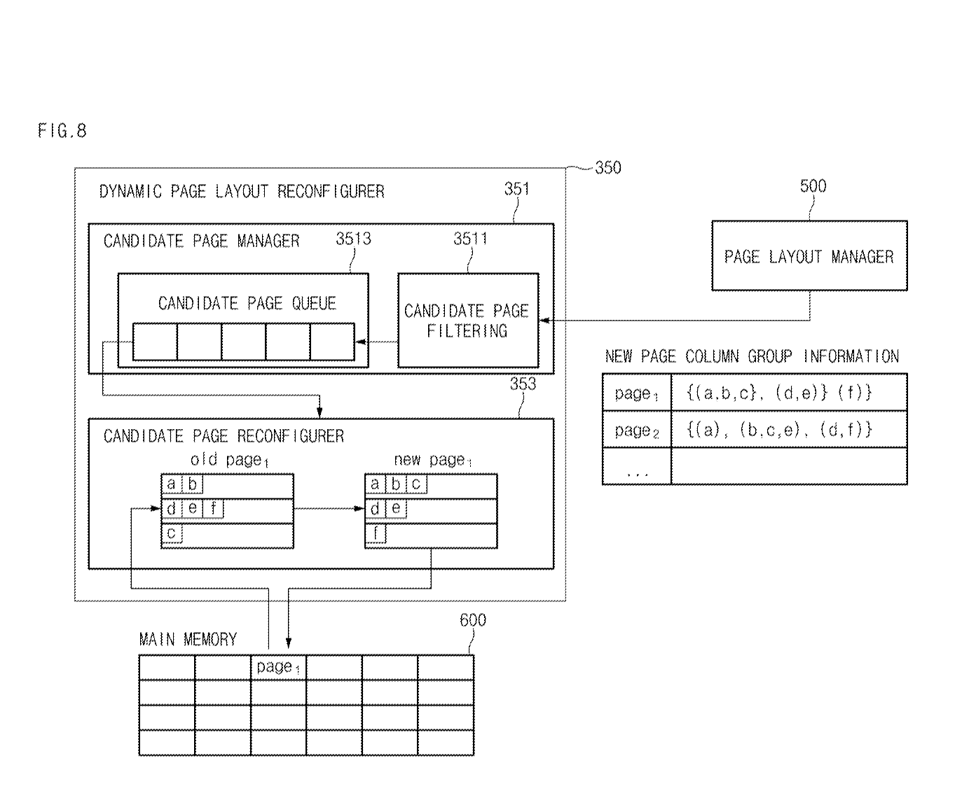

FIG. 8 is a diagram for describing a page layout reconfiguring method according to an embodiment of the present invention.

Referring to FIG. 8, the dynamic page layout reconfigurer 350 provided in the data storage manager 300 receives new page column group information created by the aforementioned method from the page layout manager 500.

The dynamic page layout reconfigurer 350 periodically receives new page column group information from the page layout manager 500. According to the embodiment, the page column group information provided from the page layout manager 500 may include layout information of all pages. The dynamic page layout reconfigurer 350 reconfigures the page by selecting as a candidate page only pages of which the number of access times during a predetermined time interval is equal to or greater than a predetermined value without reconfiguring all pages.

According to the embodiment, the dynamic page layout reconfigurer 350 may include a candidate page manager 351 and a candidate page reconfigurer 353.

The candidate page manager 351 may include a candidate page filtering unit 3511 selecting a candidate page with a workload having the number of access times equal to or greater than a predetermined number of access times among a plurality of pages based on the page monitoring information and a candidate page queue 3513 storing the candidate pages and page column group information corresponding to each candidate page.

The candidate page reconfigurer 353 compares the page column group information of the candidate page and a column group of a candidate page on the main memory 600. In other words, it is determined whether a column layout pattern of the candidate page stored in the current main memory 600 is the same as newly created page column group information and if the column layout pattern is the same as the newly created page column group information, a separate reconfiguration operation need not be performed. If the column layout pattern is stored not to be the same as the newly created page column group information, the candidate page is reconfigured to correspond to the page column group information.

Referring to FIG. 8, a column group of the candidate page stored in the memory is represented by ‘old page₁’ and the newly created page column group information is represented by ‘new page₁’.

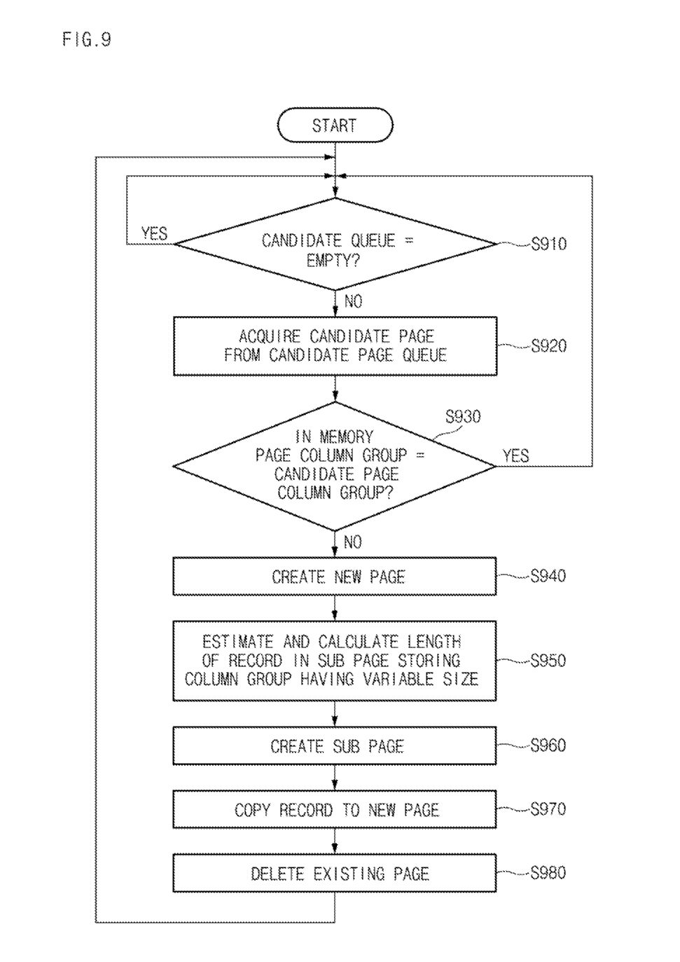

FIG. 9 is a flowchart for describing an operation of a candidate page reconfigurer according to an embodiment of the present invention.

Referring to FIG. 9, the candidate page reconfigurer 353 reconfigures the candidate page by reading the candidate page and the page column group information corresponding thereto from the candidate page queue 3513 included in the dynamic page layout reconfigurer 350.

When the candidate page manager 351 stores a page to be reconfigured in the candidate page queue 3513, the candidate page reconfigurer 353 reads page information from the candidate page queue 3513. When the candidate page queue 3513 is empty, the candidate page reconfigurer 353 stands by until a new page enters the candidate page queue 3513 (step S910).

The candidate page reconfigurer 353 acquires the candidate page and the page column group information corresponding thereto from the candidate page queue 3513 (step S920).

The candidate page reconfigurer 353 compares the column group information of the candidate page and the column information of the page stored in the main memory 600 (step S930). When column group information of both pages is the same with each other (step S930, Yes), the page need not be reconfigured, and as a result, the candidate page reconfigurer 353 reads a new candidate page and page column group information corresponding thereto from the candidate page queue 3513.

When the column group information between both pages is not the same with each other (step S930, No), a new memory space is allocated to the main memory 600 to create a new page (step S940).

Referring to FIG. 8, in ‘old page₁’ which is the column information of the page stored in the memory, it may be verified that the column group is constituted by {a, b}, {d, e, f}, and {c}. However, the column group information of ‘new page₁’ is different from that of ‘old page₁’. Therefore, the candidate page reconfigurer 353 is allocated with a new region in the main memory 600 to create a new page.

The new page is constituted by sub pages based on the column groups. For example, referring to ‘new page₁’ which is the new page column group information of FIG. 8, page₁ is constituted by a sub page {a, b, c}, a sub page {d, e}, and a sub page {f}.

The candidate page reconfigurer 353 estimates and calculates a record length of the sub page constituting the candidate page based on the page column group information (step S950).

The size of the record stored in each column should be determined in order to determine the size of each sub page. When the size of the data stored in the column is fixed, the size of the record in the column may be calculated by the sum of the respective column sizes. For example, when the size of the data stored in each column is fixed to 8 Kbyte, the size of the sub page {a, b, c} of a first page page₁ is calculated as 24 Kbyte, the size of the sub page {d, e} is calculated as 16 Kbyte, and the size of the sub page {f} is calculated as 8 Kbyte.

Unlike this, when the size of the data stored in the column is variable, since the size of the record stored in the column may not be known, the size of the record is estimated. The size of the record may be estimated by calculating an average value of data sizes of corresponding columns stored in the existing page. For example, when the first page page₁ of the main memory 600 is constituted by 5 columns and the total size of the first page page₁ is 30 Kbyte, one column is estimated to have a size of 6 Kbyte. The sizes of the respective sub pages may be calculated according to the estimated average column size, i.e., the sub page of {d, e}, and the sub page of {f} may be calculated as 18 Kbyte, 12 Kbyte, and 6 Kbyte, respectively.

After the record size of each sub page is calculated, the sub pages in the page are created (step S960). After the sub page is created in the page, data is copied from the page (old page₁ of FIG. 8) stored in the existing main memory 600 to store data in a newly allocated page (step S970). After the copy is completed, a page reconfiguration process is ended by deleting the existing page (step S980).

When total performance of the data managing apparatus 10 is considered, a task of reconfiguring the page should be performed separately from a task of performing a data operation depending on the query. Therefore, when the page reconfiguration task is performed, the page reconfiguration task is executed by a separate background process, and as a result, the background process performing the page reconfiguration performs the page reconfiguration task for the corresponding page when the page enters the candidate page queue 3513 after staying in a stand-by state when the candidate page queue 3513 is empty as illustrated in FIG. 9, and when the candidate page queue 3513 is empty, the background process returns to the stand-by state.

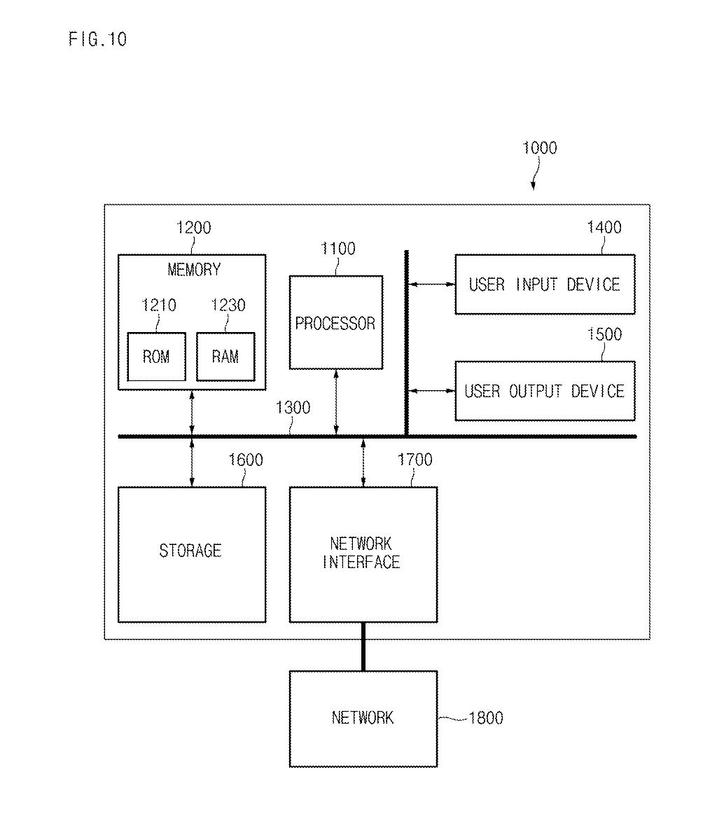

FIG. 10 is a block diagram illustrating a computer system for performing the method of managing data. In addition, the computer system illustrated in FIG. 10 may also include the apparatus of managing data according to the present invention.

An embodiment of the present invention may be implemented in a computer system, e.g., as a computer readable medium. As shown in FIG. 10, a computer system 1000 may include one or more of a processor 1100, a memory 1200, a user input device 1400, a user output device 1500, and a storage 1600, each of which communicates through a bus 1300. The computer system 1000 may also include a network interface 1700 that is coupled to a network 1800. The processor 1100 may be a central processing unit (CPU) or a semiconductor device that executes processing instructions stored in the memory 1200 and/or the storage 1600. The memory 1200 and the storage 1600 may include various forms of volatile or non-volatile storage media. For example, the memory may include a read-only memory (ROM) 1210 and a random access memory (RAM) 1230. The user input device 1400 and the user output device 1500 may perform interfacing operation for receiving user instructions or outputting message of the system to a user.

Accordingly, an embodiment of the present invention may be implemented as a computer implemented method or as a non-transitory computer readable medium with computer executable instructions stored thereon. In an embodiment, when executed by the processor, the computer readable instructions may perform a method according to at least one aspect of the invention.

As described above, the apparatus of managing data and the method of managing data according to the present invention analyze a page depending on the query and an in-page column access characteristic at a predetermined time interval to reconfigure the columns in the page suitable for the workload. Therefore, all of the mixed workloads may be supported and an operation speed is improved.

It will be obvious to a person of ordinary skill in the art that various substitutions, modifications, and changes may be made within the scope of the technical spirit of the present invention.

What is claimed is:

1. An apparatus of managing data, the apparatus comprising:
a query processor configured to process a user query;
a page monitor configured to collect accessed column information and selectivity information of accessed columns from the query processor at the time of processing the user query and collect access page information at the time of processing the user query from a data storage manager to create page monitoring information;
a page layout manager configured to create page column group information by grouping columns adjacent to each other for each page at a predetermined time interval based on the page monitoring information; and
the data storage manager configured to store data in a main memory by reconfiguring a page based on the page column group information for a candidate page of which an access frequency is greater than a predetermined access frequency based on the page monitoring information.

2. The apparatus of claim 1, wherein the page layout manager creates a combination of column groups having minimum cost as the page column group information by grouping a plurality of columns constituting the page based on a cost model for each page.

3. The apparatus of claim 2, wherein the data storage manager includes:
a candidate page filtering unit configured to select the candidate page based on the page monitoring information; and
a dynamic page layout reconfigurer including a candidate page reconfigurer configured to reconfigure the candidate page by comparing page column group information of the candidate page and a column group of the candidate page on the main memory.

4. The apparatus of claim 3, wherein the candidate page reconfigurer calculates the sizes of sub pages constituting the candidate page based on the page column group information to create each sub page in a newly allocated page on the main memory.

5. The apparatus of claim 4, wherein the candidate page reconfigurer copies and stores data written in the column of the candidate page in the newly allocated page on the main memory according to the page column group information, and the candidate page reconfigurer deletes the data written in the column of the candidate page when the copying is completed.

6. The apparatus of claim 2, wherein the page layout manager clusters columns to one or more groups for each page, creates a combinational column group for each group, and selects a candidate column group by applying the cost model to the combinational column group to create the page column group information.

7. The apparatus of claim 6, wherein the page layout manager creates the page column group information so as to create the column group in a pattern of a single cluster for each page.

8. A method of managing data, the method comprising:
creating page monitoring information by collecting accessed column information, selectivity of accessed columns, and access page information at the time of processing a user query;
creating page column group information at a predetermined time interval by grouping columns adjacent to each other for each page based on the page monitoring information;
reconfiguring a candidate page of which an access frequency is more than a predetermined access frequency based on the page column group information, the candidate page reconfigured being selected based on the page monitoring information; and
storing data in a main memory based on the reconfigured page column group information.

9. The method of claim 8, wherein the creating of the page column group information includes selecting a combination of column groups having minimum cost by grouping a plurality of columns constituting the page based on a cost model for each page to create the selected combination as the page column group information.

10. The method of claim 8, wherein the creating of the page column group information includes:
clustering columns constituting the page to a group constituted by one or more columns;
creating combinational column groups corresponding to available column combinations for each clustered group;
selecting a candidate column group by applying a cost model to the combinational column groups; and
selecting the combination of the candidate column group having minimum cost when the page is constituted to create the selected combination as the page column group information.

11. The method of claim 10, wherein the creating of the page column group information is repeatedly performed until the number of the clustered groups decreases to one.

12. The method of claim 8, wherein the reconfiguring of the page includes:
selecting the candidate page among pages constituting the main memory;
comparing the page column group information of the candidate page and the column group of the candidate page on the main memory; and
reconfiguring the candidate page based on the comparison result.

13. The method of claim 12, further comprising:
calculating the size of the sub page constituting the candidate page based on the page column group information.

14. The method of claim 13, wherein the calculating of the size of the sub page includes calculating the size of the sub page by averaging the size of the candidate page of the main memory by the number of columns when the sizes of records stored in columns constituting the sub page are variable.

15. The method of claim 12, wherein the storing of the data in the main memory includes:
allocating a new page on the main memory; and
copying and storing data written in the candidate page on the main memory to and in the allocated page.
